(19) United States
(12) Patent Application Publication
(10) Pub. No.: US 2013/0056497 A1
(43) Pub. Date: Mar. 7, 2013

(54) WIPER FOAM PUMP, REFILL UNIT & DISPENSER FOR SAME

(71) Applicants: John J. McNulty, Broadview Heights, OH (US); Robert L. Quinlan, Stow, OH (US); Todd A. Spiegelberg, North Ridgeville, OH (US)

(72) Inventors: John J. McNulty, Broadview Heights, OH (US); Robert L. Quinlan, Stow, OH (US); Todd A. Spiegelberg, North Ridgeville, OH (US)

(73) Assignee: GOJO INDUSTRIES, INC., Akron, OH (US)

(21) Appl. No.: 13/605,171

(22) Filed: Sep. 6, 2012

Related U.S. Application Data
(60) Provisional application No. 61/531,935, filed on Sep. 7, 2011.

(51) Int. Cl. A47K 5/14; B65B 3/04; B05B 7/26

(52) U.S. Cl. 222/190; 239/311; 53/473; 222/214

(57) ABSTRACT

Foam dispensers and pumps for use in foam dispensers are disclosed herein. In one embodiment, a foam dispenser system includes a liquid container for holding a foamable liquid. A flexible and resilient liquid delivery compressible member connects the liquid container to a mixing chamber. A flexible and resilient air delivery compressible member connects a source of air to the mixing chamber. A compression member compresses the compressible members to move liquid and air into the mixing chamber to become a foam. The liquid container and the liquid delivery compressible member may both be disposed in a removable and replaceable refill unit assembly.

### CROSS REFERENCE TO RELATED APPLICATION

This non-provisional application claims priority to, and the benefits of, U.S. Provisional Patent Application Ser. No. 61/531,935 filed Sep. 7, 2011, which is entitled WIPER FOAM PUMP, REFILL UNIT & DISPENSER FOR SAME, and which is incorporated herein by reference in its entirety.

### TECHNICAL FIELD

The present invention relates generally to foam dispenser systems and more particularly to a wiper pump, refill unit and a foam dispenser system including a compression member and one or more flexible and resilient compressible members.

### BACKGROUND OF THE INVENTION

Liquid dispensers, such as liquid soap and sanitizer dispensers, provide a user with a predetermined amount of liquid upon actuation of the dispenser. In addition, it is sometimes desirable to dispense the liquid in the form of foam by, for example, injecting air into the liquid to create a foamy mixture of liquid and air bubbles.

### SUMMARY

Foam dispensers and pumps for use in foam dispensers are disclosed herein. In one embodiment, a foam dispenser system includes a liquid container for holding a foamable liquid. A flexible and resilient liquid delivery compressible member connects the liquid container to a mixing chamber. A flexible and resilient air delivery compressible member connects a source of air to the mixing chamber. A compression member compresses the compressible members to move liquid and air into the mixing chamber to become a foam. The liquid container and the liquid delivery compressible member may be disposed in a common removable and replaceable refill unit assembly.

In this way a simple and economical foam dispenser system, as well as a refill unit, are provided.

### BRIEF DESCRIPTION OF THE DRAWINGS

These and other features and advantages of the present invention will become better understood with regard to the following description and accompanying drawings in which:

FIG. 1 is a perspective illustration of an exemplary embodiment of a foam dispenser system 100 that includes a flexible and resilient liquid delivery tube 106, two flexible and resilient air delivery tubes 112, and a roll bar 116 compression member;

FIG. 2 is a schematic illustration of one example of a lever actuator 200 which may be used in the system 100;

FIG. 3 is a cross-sectional illustration of a specific embodiment 300 of the system 100, in which a refill unit 350 includes all of the liquid storage and delivery elements; and

FIG. 4 illustrates an exemplary method 400 for producing a removable and replaceable refill unit for a foam dispenser.

### DETAILED DESCRIPTION

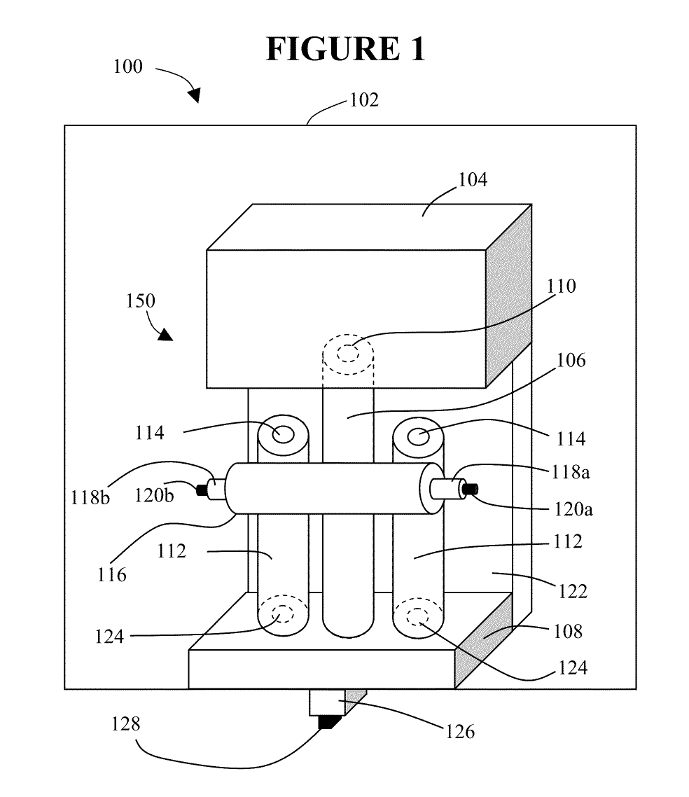

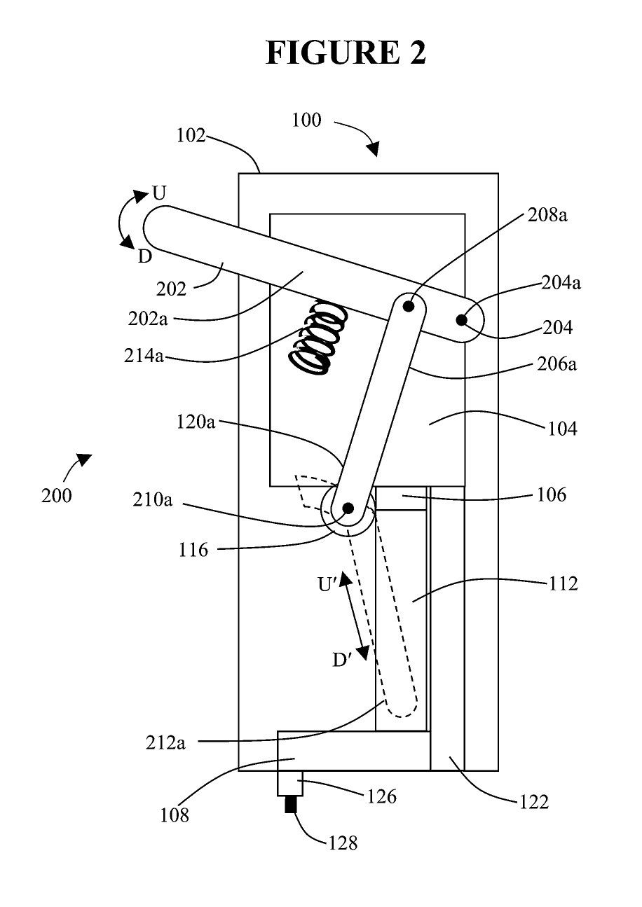

FIGS. 1 and 2 illustrate an exemplary embodiment of a foam dispenser system 100. The exemplary foam dispenser system 100 includes a rigid outer housing 102 shown schematically in the Figures. A liquid container 104 holds a supply of a foamable liquid within the outer housing 102. In various embodiments, the contained liquid could be for example a soap, a sanitizer, a cleanser, a disinfectant, or some other foamable liquid. The liquid container 104 may be a rigid box-like container, a collapsible container, a flexible bag-like container, or have any other suitable configuration for containing the foamable liquid without leaking. The liquid container 104 may advantageously be refillable, replaceable, or both refillable and replaceable. In other embodiments the liquid container 104 may be neither refillable nor replaceable. A replaceable liquid container refill unit may comprise a liquid container 104 combined with a liquid delivery tube 106, and perhaps other components, in one assembly. A mechanical locking mechanism (not shown) may be provided to lock or hold a replaceable liquid container 104 in place within the outer housing 102. In one specific embodiment described below, the liquid container 104, liquid delivery tube 106, air delivery tube 112, mixing chamber 108, foaming chamber 126 and foaming outlet 128 form a refill unit 150 that may be readily removed from housing 102 and replaced.

A flexible and resilient liquid delivery tube 106 is connected to the liquid container 104, and leads to a mixing chamber 108. As used herein, “flexible and resilient” means a compressible member such as a tube 106 may be deformed by pressure exerted on the compressible member by a compression member, and then expands back to substantially its original shape upon removal of the compression member from the compressible member. Preferably, the compressible member can withstand several hundred or several thousand compression cycles without leaking or having some other failure.

While the illustrated embodiment includes one liquid delivery tube 106, in additional embodiments two or more liquid delivery tubes 106 may be employed. Each liquid delivery tube 106 may carry the same liquid as every other tube, or different liquid delivery tubes 106 may carry different liquids for mixing in the mixing chamber 108. In the latter event, there may also be separate liquid containers 104 for each different liquid.

The liquid delivery tube(s) 106 may be made of any material which is suitable for transporting the liquid without leaking, and which can withstand the required compression cycles. In some embodiments, the tube material may have a Shore A hardness of between about 30 and about 90. Suitable materials may include, for example, latex; thermoplastic elastomer (TPE); polyisoprene; thermosetting rubber such as EPDM; silicone; PVC; EPDM+polypropylene (for example SANTOPRENE); polyurethane; neoprene; and others. The liquid tube channel(s) should be large enough to allow efficacious dosing of the foamable liquid in one compression cycle. In some embodiments, the channel diameter may be between about 0.125 and about 0.500 inches. The liquid tube channels may have a substantially constant diameter throughout their length, or alternatively the channel diameter may include at least one decreasing diameter portion to increase the velocity of liquid delivery into the mixing chamber 108. In some embodiments, the tube(s) 106 may have an interior lining in the tube channel in order to promote faster or more reliable liquid transport, or for some other purpose.

The connection between the liquid delivery tube 106 and the liquid container 104 may be releasable, such as a threaded connection, a snap fit connection, a friction fit connection, or other releasable connection. The connection may alternatively be permanent, such as by an integral joining, an adhesive joining, or a welded joining, or by being integrally formed with container 104. In any event, the connection prevents spillage of the liquid as it travels from the liquid container 104 into the liquid delivery tube 106. A similar connection is made between the liquid delivery tube 106 and the mixing chamber 108. For example, the container 104 may be permanently connected to the tube 106, with the tube 106 in turn being releasably connected to the mixing chamber 108. In that way, the container 104 and the tube 106 form a single, replaceable refill unit assembly. In additional embodiments, tube 106 may be permanently connected to mixing chamber 108.

In some embodiments, the connection between the liquid container 104 and the liquid delivery tube 106 may include a one-way check valve 110 to allow liquid to flow only one way, from the container 104 into the tube 106. Such a one-way check valve 110 may be, for example, a flapper valve, a conical valve, a plug valve, an umbrella valve, a duck-bill valve, a ball valve, a slit valve, a mushroom valve, or any other one-way liquid check valve. In yet further embodiments, the one-way check valve 110 may have a cracking pressure of between about 1 and about 5 psi.

The outer housing 102 also holds two flexible and resilient air delivery tubes 112 which lead from their respective air inlets 114 to the mixing chamber 108. The air inlets 114 receive air from an air source. In the exemplary embodiment shown in FIGS. 1 and 2, the air source is the outside atmosphere. In particular, air passes from the outside atmosphere and into the air inlets 114 via air holes in the outer housing 102 providing for air travel (not shown). Other embodiments, not shown in the Figures, may forego dedicated air holes in favor of an outer housing 102 composed of multiple pieces which are connected to each other in an air permeable manner. In various additional embodiments not shown in the Figures, an air filter may be disposed either within or next to the air holes of the outer housing 102 or the air inlets 114 of the air delivery tubes 112 to purify the air entering the tubes. The air source may also be an air compressor (not shown) in the outer housing 102 which provides a supply of compressed or pressurized air to the air inlets 114 of the air delivery tubes 112. The air compressor may be, in various examples, a piston pump, a bellows pump, or a dome pump. While the illustrated embodiment includes two air delivery tubes 112, in additional embodiments one air delivery tube 112 or three or more air delivery tubes 112 may be employed.

The air delivery tube(s) 112 may be made of any material which is suitable for transporting air without leaking, and which can withstand the required compression cycles. Suitable materials include, for example, the same materials identified above in connection with the liquid delivery tube(s) 106. The air delivery tube channels should be large enough to allow efficacious dosing of air to create foam in one compression cycle. In some embodiments, multiple air tubes 112 having a channel diameter of between about 0.250 and about 1.0 inches may be provided. The air tube channels may have a substantially constant diameter throughout their length, or alternatively the channel diameter may include a decreasing diameter portion to increase the velocity of air delivery into the mixing chamber 108. An air delivery tube may, in yet further embodiments, be in the form of an air bladder or other non-tube-shaped element of sufficient size to provide substantially more air than liquid during a compression cycle.

A pump actuator extends outside of the outer housing 102. The pump actuator shown in FIG. 2 is one example of a manual lever actuator 200. Thus, in that embodiment 200 the actuator includes a lever arm 202 which is generally U-shaped, having a central horizontal push bar extending between two legs 202a and 202b. Only one such leg 202a is seen in FIG. 2. The central horizontal push bar is located exterior of the outer housing 102. The two lever arm legs 202a and 202b each extend into the outer housing 102, to be pivotally mounted at respective pivot points 204a and 204b, one on each side of the liquid container 104 to define a common pivot axis 204. The U-shaped lever arm 202 may rotate up “U” and down “D” around the pivot axis 204. FIG. 2 shows the lever arm 202 in an “at rest” rotatable position, where the lever arm 202 will be without any force being applied to the exterior push bar. Separate, identical linkages are provided on each side of the lever arm 202, only one of which is shown in FIG. 2. In that illustrated side linkage, the upper end of an intermediate arm 206a is pivotally connected to the lever arm leg 202a at a pivot point 208a. The lower end of the intermediate arm 206a is pivotally connected to a roll bar 116 at a pivot point 210a. For this purpose, and as shown in FIG. 1, each end of the roll bar 116 is configured with a protrusion 118 and a pin 120. The protrusions 118a and 118b respectively fit into channels 212a and 212b defined in interior walls within the outer housing 102. One channel 212a is shown in dotted lines in FIG. 2; the corresponding interior wall defining the channel 212a is not shown. The pins 120a and 120b are respectively rotatably received in apertures within the intermediate arms 206a and 206b to form the pivot points 210a and 210b.

The illustrated lever arm actuator 200 operates in the following manner. When a user rotates the lever arm 202 downwardly D, that downward motion is transferred to the roll bar 116 by the intermediate arms 206a and 206b. The motion of the roll bar 116 is, however, constrained by the capture of the protrusions 118a and 118b within the channels 212a and 212b. Thus, as the lever arm 202 rotates downward D, the roll bar 116 follows the downward path D′ defined by the channels 212a and 212b. The direction of travel D′ lies generally along, but not exactly parallel to, the longitudinal axes of the tubes 106, 112 and 112. The path D′ is slightly angled so that the roll bar 116 is forced up against all three flexible and resilient tubes 106, 112 and 112 at once, causing them to constrict against an opposing wall 122. This forced constriction of the flexible tubes causes liquid to exit the liquid delivery tube 106 into the mixing chamber 108, and air to exit the air delivery tubes 112 into the mixing chamber 108. In this way the roll bar 116 acts as a compression member and the tubes 106, 112 and 112 act as flexible and resilient compressible members. The liquid and air delivered in to the mixing chamber 108 are mixed to form a foam, as described further below.

After the downward pumping action D is completed, the user releases the lever arm 202. The lever actuator 200 may be returned to its rest position by, for example, a linear compression spring 214a attached between the lever arm leg 202a and the outer housing 202. When a user rotates the lever arm 202 downwardly D to operate the pump, the compression spring 214a is being compressed. Then, when the user releases the lever arm 202, the compression spring 214a expands to move the lever actuator 200 back to the rest position shown in FIG. 2. A second such compression spring may also be attached to the other leverage arm leg 202b (not shown). Of course, linear expansion springs can be employed in a like manner, as can torsion springs, motors, and many other restoring force elements.

In further embodiments, due to their resilient properties, the tubes 106, 112 and 112 will expand from their constricted condition. That expansion of the tubes, in turn, pushes the roll bar 116 upwardly U′ within the channels 212. The upward motion U′ of the roll bar 116 is transferred into an upward motion U of the lever arm 202 by the intermediate arms 206a and 206b. In this way, the natural resiliency of the tubes pushes the lever actuator 200 back to the rest position shown in FIG. 2. As a result, the tubes 106, 112 and 112 expand back to substantially their original shapes, with open channels. Thus, foamable liquid stored in the liquid container 104 is gravity-fed down into the liquid delivery tube 106. Similarly, air enters the air delivery tubes 112 via the air inlets 114. In that way the pump actuator is made ready for another actuation.

As will be appreciated, the rest position of the exemplary lever actuator 200 as shown in FIG. 2 is an “open” position. That is, the compressible members are not being compressed in the rest position. In alternative embodiments, the rest position of the pump actuator is “closed.” In such embodiments, the compressible members are being compressed by the compression member in the rest position of the pump actuator. When actuated, the pump then releases the compression so the compressible members can be re-filled with liquid and air. As the pump returns to its compressed rest position, the compression causes the liquid and air to exit the compressible members.

As already stated, the pump actuator shown in FIG. 2 is one example of a manual lever actuator 200. However, as will be appreciated by one of ordinary skill in the art, there are many other different kinds of pump actuators which may be employed. In yet further embodiments the pump actuator may be any type of actuator, such as, for example, a different kind of lever actuator, an electrically activated actuator, a manual pull bar, a manual push bar, a manual rotatable crank, or other means for actuating the foam dispenser system 100. Electronic pump actuators may additionally include a motion detector to provide for a hands-free dispenser system with touchless operation.

During operation of the foam dispenser system 100, the air delivery tubes 112 preferably remain dry or free from liquids and foamy mixtures because those elements are prevented from traveling from the mixing chamber 108 up into the air delivery tubes 112. It is desirable to prevent the air delivery tubes 112 from being contaminated with the liquid or foam to prevent bacteria from growing in the air delivery tubes 112, especially if the air delivery tube 112 remains with the dispenser and is not replaced with the refill unit. This may be accomplished, for example, by one-way sealing valves 124 disposed at the connection points between the air delivery tubes 112 and the mixing chamber 108. The one-way sealing valves 124 may be any type of one-way liquid/air valve, such as for example, a wiper seal, a shuttle valve, or a ball-and-spring valve. The sealing valves 124 are sanitary seals in that they prevent liquid and foam from contaminating the air tubes 112 or coming into contact with elements of the foam dispenser system 100 that are located outside of the intended liquid and foam delivery path. If such sanitary seals are used, the refill unit 150 need not include air delivery tubes 112 which could be reusable.

As discussed above, the liquid delivery tube 106 and the air delivery tubes 112 respectively deliver a foamable liquid and air to the mixing chamber 108. Once in the mixing chamber 108, the foamable liquid and the air mix together in a swirling motion to form a mixture that is expelled into a foaming chamber 126.

In a preferred embodiment, the air to liquid ratio in the mixture is approximately 10:1, but any ratio may be provided. The air to liquid ratio is determined by the relative number and size of the liquid and air delivery compressible members. For example, decreasing the number of air delivery compressible members or increasing the number of liquid delivery compressible members will decrease the air to liquid ratio. Similarly, increasing the number of air delivery compressible members or decreasing the number of liquid delivery compressible members will increase the ratio. This ratio may alternatively be varied by changing the internal volume of the compressible members, such as by increasing or decreasing the channel diameters of the tubes 106, 112 and 112. Once the proper number and size of compressible members is chosen to provide the desired air to liquid ratio, a consistently accurate dosing is thereafter provided.

The liquid-air mixture is enhanced into a rich foam in the foaming chamber 126. For example, the foaming chamber 126 may house one or more foaming elements therein. Suitable foaming elements include, for example, a screen, mesh, porous membrane, or sponge. Such foaming element(s) may be disposed in a foaming cartridge within the foaming chamber 126. As the liquid/air mixture passes through the foaming element(s), the mixture is turned into an enhanced foam. In some embodiments, the mixing and foaming action may both occur in one single chamber, which is then both a mixing chamber and a foaming chamber. The foam is dispensed from the foaming chamber 126 through a foam outlet 128.

In some embodiments, the foam outlet 128 is simply a channel or aperture leading from the foaming chamber 126 to the outside atmosphere surrounding the outer housing 102. In other embodiments, the foam outlet 128 may include a one-way check valve to prevent back flow of foam from the foam outlet 128 into the foaming chamber 126 or to prevent unwanted discharge while the dispenser is not being used. Such a one-way check valve may be, for example, a slit valve or any of the types identified above in relation to the connection between the liquid container 104 and the liquid delivery tube 106.

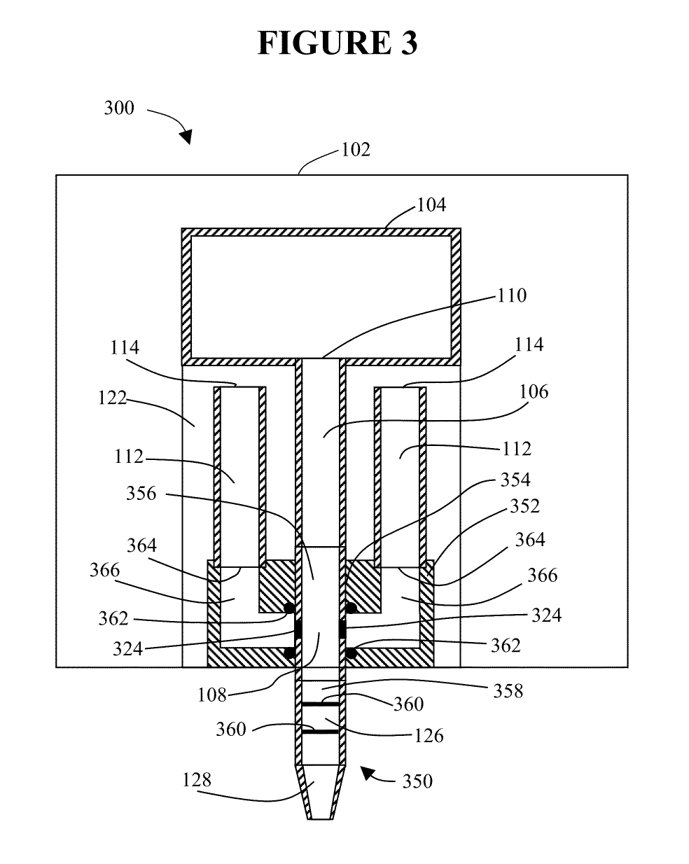

FIG. 3 is a cross-sectional illustration of a specific embodiment 300 of the system 100, in which a removable and replaceable refill unit 350 includes all of the liquid storage and delivery elements of the system 300. Thus, in the system 300, the mixing chamber 108 is located within a manifold support member 352 disposed within the outer housing 102. The manifold support member 352 may be formed, for example, from a rigid plastic material. The refill unit 350 is held within a central bore 354 of the manifold support member 352, such that the unit 350 is removable and replaceable.

The removable and replaceable refill unit 350 includes the liquid container 104 and the liquid delivery tube 106, as described above. It additionally includes, however, a mixing member 356, a foaming member 358, and the foam outlet 128. These additional elements may be formed, for example, from a rigid plastic material. The mixing member 356 defines the mixing chamber 108. The foaming member 358 defines the foaming chamber 126, which may optionally include foaming elements such as the two screens 360 illustrated in FIG. 3. In addition embodiments (not shown), the mixing chamber 108 and the foaming chamber 126 may both be defined by one single member, and may further comprise the same chamber within that one single member. Sealing members, such as the illustrated o-rings 362, may be used to form a seal between air channels 366 and mixing chamber 108.

The air delivery tubes 112 are connected to the manifold support member 352 at respective air inlets 364. Air channels 366 lead from the air inlets 364 to an interface with the mixing member 356 of the refill unit 350 within the bore 354. One way sealing valves 324 as described above may be disposed within the mixing member 356, to permit air to flow from the channels 366 into the mixing chamber 108, while preventing liquid or foam from contaminating the air channels 366 or the air delivery tubes 112.

In the illustrated system 300, the manifold support member 352 and the air delivery tubes 112 remain within the outer housing 102 when the refill unit 350 is replaced. In alternative embodiments (not shown), a removable and replaceable refill unit may include the manifold support member and the air delivery tubes. In this way the manifold support member and the air delivery tubes are easily removable and replaceable.

The system 300 functions as already described above in connection with the more general embodiment 100. That is, operation of a compression member (not shown in FIG. 3) compresses the compressible members 106, 112 and 112 to force air and liquid into the mixing chamber 108 and foaming chamber 126. A foam is thereby created which exits the system 300 via the foam outlet 128. One of the advantages provided by the specific system 300 is that the removable and replaceable refill unit 350 includes all of the liquid storage and liquid delivery elements, which allows the air delivery components to be reused.

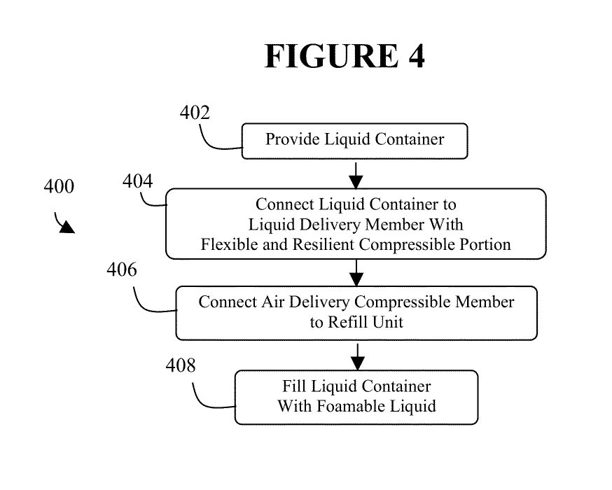

FIG. 4 illustrates an exemplary method 400 for producing a removable and replaceable refill unit for a foam dispenser. Although the exemplary method is presented in a specific order, no particular order is required to perform these steps, and various combinations or groupings of different steps may be used in accordance with the present invention. The exemplary method 400 includes providing 402 a liquid container for holding a supply of foamable liquid. A liquid delivery member is connected 404 to the liquid container. The connection may be releasable or permanent, including an integral formation of the container and the delivery member. The liquid delivery member has a flexible and resilient compressible portion. In some embodiments, the method 400 may additionally include connecting 406 a flexible and resilient air delivery compressible member to the refill unit. When the refill unit is placed within the foam dispenser, a compression member within the foam dispenser compresses the compressible portion(s) to operate the dispenser. The liquid container 104 is filled 408 with a foamable liquid, and is ready for shipment.

The exemplary foam dispenser system 100 may allow for a simple and inexpensive replacement of the liquid supply in the foam dispenser system. Once the supply of foamable liquid in the liquid container 104 runs out, the now-empty container 104 may be replaced with a new container 104 filled with a supply of foamable liquid. In this way, only a single sanitary fluidic connection needs to be unmade to remove the empty container and then re-made to insert the new container. The rest of the system 100 remains in place.

The exemplary foam dispenser system 100 may also be easily modified to become a foamless, liquid-only dispenser system. One need only replace the air delivery tubes 112, 112 with a seal to close the air inlets to the mixing chamber 108. This permits the making of two different kinds of pumps from essentially one design, providing manufacturing and maintenance efficiencies.

The exemplary foam dispenser system 100 further allows a relatively compact pump design. It achieves its compactness by employing only one compression member, which compresses multiple longitudinally extending compressed members arranged in a row such that their longitudinal axes are co-planar. That design results in only a very few required components to operate the pump, leading to a compact pump.

While the present invention has been illustrated by the description of embodiments thereof and while the embodiments have been described in considerable detail, it is not the intention of the applicants to restrict or in any way limit the scope of the appended claims to such detail. Additional advantages and modifications will readily appear to those skilled in the art. For example, the compression member may directly compress a flexible and resilient liquid container 104 rather than a liquid tube or other compressible element connected to the liquid container 104. Moreover, elements described with one embodiment may be readily adapted for use with other embodiments. Therefore, the invention, in its broader aspects, is not limited to the specific details, the representative apparatus and illustrative examples shown and described. Accordingly, departures may be made from such details without departing from the spirit or scope of the applicants' general inventive concept.

We claim:

1. A foam dispenser comprising:
a liquid container for holding a foamable liquid;
a flexible and resilient liquid delivery compressible member connecting the liquid container to a mixing chamber;
a flexible and resilient air delivery compressible member connecting a source of air to the mixing chamber, such that the foamable liquid mixes with air within the mixing chamber;
a foaming chamber fluidically connected to the mixing chamber;
a foam outlet located downstream of the foaming chamber; and
an actuator for a compression member;
wherein the compression member is configured to compress at least one of the compressible members to move liquid and air into the mixing chamber wherein the liquid and air form an initial mixture which is enhanced into a foam in the foaming chamber and passes out of the foam dispenser through the foam outlet.

2. The foam dispenser of claim 1 wherein the compression member comprises a roller.

3. The foam dispenser of claim 1, wherein the source of air is at atmospheric pressure, and the foamable liquid is gravity-fed from the liquid container to the liquid delivery compressible member.

4. The foam dispenser of claim 1, wherein the air to liquid ratio of the initial mixture is 10:1.

5. The foam dispenser of claim 1, further comprising a one-way sealing valve disposed between the air delivery compressible member and the mixing chamber.

6. The foam dispenser of claim 1, wherein a foaming element is disposed within the foaming chamber.

7. The foam dispenser of claim 1, further comprising a refill assembly including the liquid container and the liquid delivery compressible member.

8. The foam dispenser of claim 1, further comprising one single compression member which is configured to compress both the liquid delivery compressible member and the air delivery compressible member.

9. The foam dispenser of claim 1, further comprising a second flexible and resilient air delivery compressible member connecting a source of air to the mixing chamber, such that the foamable liquid mixes with air within the mixing chamber.

10. The foam dispenser of claim 1, further comprising a second flexible and resilient liquid delivery compressible member connecting a second liquid container to the mixing chamber.

11. The foam dispenser of claim 10, wherein the two liquid containers respectively hold a first foamable liquid and a second foamable liquid, wherein the first foamable liquid is different than the second foamable liquid, such that the first and second foamable liquids mix with air within the mixing chamber.

12. The foam dispenser of claim 1, further comprising an actuator for the compression member, the wherein the actuator comprises:
a lever actuator comprising a lever arm located exterior of an outer housing for the dispenser, and a leg extending into the outer housing;
an intermediate arm comprising a first end which is pivotally connected to the lever arm leg, and a second end which is connected to the compression member.

13. The foam dispenser of claim 12, further comprising an interior wall within the outer housing which includes a channel angled toward the liquid delivery compressible member and the air delivery compressible member, and wherein the compression member further comprises a protrusion which fits into the wall channel such that the compression member is forced up against the compressible members as the lever arm is rotated by a user of the dispenser.

14. The foam dispenser of claim 1, wherein the liquid delivery compressible member comprises a tube and the air delivery compressible member comprises a tube.

15. The foam dispenser of claim 1, wherein the liquid container comprises the flexible and resilient liquid delivery compressible member.

16. A removable and replaceable refill unit for a foam dispenser, wherein the foam dispenser includes a compression member configured to compress a flexible and resilient compressible portion of the refill unit, the refill unit comprising:
a liquid container;
a foamable liquid contained within the liquid container; and
a liquid delivery member comprising a first end connected to the liquid container and a second end configured to connect to the foam dispenser;
wherein the flexible and resilient compressible portion of the refill unit is disposed between the first end and the second end.

17. The refill unit of claim 16, further comprising a mixing member, a foaming member, and a foam outlet.

18. The refill unit of claim 17, wherein the mixing member and the foaming member comprise one single member which defines both a mixing chamber and a foaming chamber.

19. The refill unit of claim 17, further comprising:
a manifold support member which defines a mixing chamber, a foaming chamber, a foam outlet, and an air delivery channel extending from an air inlet to the mixing chamber; and
a flexible and resilient air delivery compressible member connecting a source of air to the air inlet, wherein the compression member of the foam dispenser is configured to compress the air delivery compressible member.

20. A method for producing a removable and replaceable refill unit for a foam dispenser, wherein the foam dispenser includes a compression member configured to compress a flexible and resilient compressible portion of the refill unit, the method comprising:
providing a liquid container for holding a supply of foamable liquid;
connecting a liquid delivery member to the liquid container, wherein the liquid delivery member includes a flexible and resilient compressible portion; and
filling the liquid container with a foamable liquid.
